(19) United States
(12) Patent Application Publication
(10) Pub. No.: US 2010/0046960 A1
(43) Pub. Date: Feb. 25, 2010

(54) IR OPTICS FOR AUDIO TRANSMISSION

(76) Inventors: Dietmar Grimm, Moeglingen (DE); Volker Burkhardt, Ehningen (DE)

Correspondence Address: KENYON & KENYON LLP, ONE BROADWAY, NEW YORK, NY, 10004, US

(21) Appl. No.: 12/541,585

(22) Filed: Aug. 14, 2009

(30) Foreign Application Priority Data
Aug. 19, 2008 (DE) 102008041337.2

(51) Int. Cl. H04B 10/00

(52) U.S. Cl. 398/156

(57) ABSTRACT

A device for vehicles for transmitting optical signals, for example infrared signals, includes an optical radiation source having a specified beam characteristic with a preferred direction. A deflecting structure is provided in the beam path downstream from the radiation source, by use of which the preferred direction of the beam characteristic may be deflected.

### FIELD OF THE INVENTION

The present invention relates to a device for vehicles for transmitting optical signals.

### BACKGROUND INFORMATION

A device for transmitting optical signals is described, for example, in German Patent No. DE 197 25 898.

The cited document describes an entertainment system for vehicles, in which infrared signals originating from a signal source are sent via fiber optics to an infrared transmitter which transmits the infrared signals to infrared receivers in the vehicle.

This involves an infrared transmitter which transmits the infrared signals to infrared receivers placed at various locations in a vehicle.

Because of the distance from the infrared receiver, the infrared transmitter has a correspondingly broad beam characteristic.

### SUMMARY OF THE INVENTION

An object of the present invention is to provide a device for transmitting optical signals which allows improved reception for receivers.

The present invention is directed to a device for vehicles for transmitting optical signals, for example infrared signals, which includes an optical radiation source which has a specified beam characteristic having a preferred direction.

A core concept of the present invention is that a deflecting structure according to the present invention is provided in the beam path downstream from the radiation source, by use of which the preferred direction of the beam characteristic may be deflected.

The present invention is based on the finding that targeted irradiation of an optical receiver may be carried out due to a deflection of the preferred direction. At the same time, optical receivers located farther outside the radiation field are not irradiated. This results in efficient irradiation of the intended receiver by the optical signal.

Such deflection of an optical signal allows a passenger, for example, to be irradiated by an optical radiation source in a targeted manner in order to supply data signals to an electronic device, for example, on the passenger or in the passenger's surroundings.

Unwanted irradiation of the driver with optical signals, such as infrared signals, for example, may thus be avoided.

In general, an optical radiation source such as an infrared radiation source, for example, transmits the optical signals in a “beam cone” to a receiver.

All receivers situated in the beam cone are able to receive signals. Beam cones of LEDs, which transmit in the infrared range, typically have a spatial angle of 10 to 60 degrees.

An array of radiation sources, in particular for infrared light, is able to transmit also using a much smaller beam cone.

Receivers located in the boundary region of the beam cone are able to receive the signal, but only with a possible unwanted loss of quality.

In addition, unwanted irradiation of a receiver which is just inside the beam cone may be regarded as objectionable.

Such disadvantages may be avoided by a targeted orientation of the preferred direction of the beam characteristic.

In one advantageous embodiment of the present invention it is provided that the deflecting structure has an inclined surface relative to the beam direction of a radiation source.

The inclined surface may cause a deflection of the beam direction of an incident infrared signal, thereby changing the preferred direction of the beam characteristic.

If, for example, an optical signal strikes the inclined surface at an angle, refraction of the optical signal occurs toward or away from the vertical to the inclined surface, depending on the particular indices of refraction present at the transition point of the inclined surface.

The optical conditions are preferably selected in such a way that refraction occurs relative to the vertical onto the inclined surface upon entry of the light.

Multiple inclined surfaces may be provided to achieve a large surface area for a deflection effect. For example, the surfaces may be provided in the shape of strips, with a plurality of strips adjacent to one another, for example.

It is further preferred for the deflecting structure to have a prism-shaped surface.

Multiple refraction surfaces are provided by a prism-shaped surface.

An individual prism of the prism-shaped surface is preferably designed in such a way that the beam direction may change direction when infrared signals strike the lateral faces of the prism.

The specified preferred direction of the infrared signal may be deflected, with respect to its angle of incidence upon striking the inclined prism faces, to a preferred direction which is different from that of the radiation source.

The prism structure is advantageously transparent to infrared light.

In a further preferred embodiment of the present invention it is provided that an optical unit is provided for bundling the optical signals.

For bundling of optical signals such as infrared signals, for example, Fresnel lenses, Fresnel lens arrays, or mirror elements, for example, may be used.

This bundling allows the signals to be further concentrated at an intended location. The reception quality of infrared signals in particular may thus be further improved.

It is further preferred that the deflecting structure is made of a black-colored material which is transparent to infrared radiation.

The infrared-transparent material used in this case has the advantage that it is not transparent to visible light.

Therefore, contours of elements situated behind the material are not visible, thus providing many application possibilities which in particular allow versatile designs to be achieved.

For example, such a device may be integrated into a central display of a vehicle.

In a further advantageous embodiment of the present invention, the deflecting structure has a small thickness in relation to its planar extension.

The design of such deflecting structures having a small thickness in relation to their planar extension has the advantage that because of its resulting small installation depth such a deflecting structure may be integrated into a number of devices, for example in a central display of a vehicle.

It is also possible to influence the deflection characteristics via a predefined material selection. In particular, the refraction characteristics may be modified in such a way that deflection occurs to the intended extent.

### BRIEF DESCRIPTION OF THE DRAWINGS

FIG. 1 shows a top view of a vehicle in which a deflection of the preferred direction of an optical signal between the transmitter and the receiver is illustrated in a highly schematic manner.

FIG. 2 shows a schematic view of a deflecting structure together with its beam characteristic.

FIG. 3 shows a perspective view of a deflecting structure in a specific embodiment having a planar extension.

### DETAILED DESCRIPTION

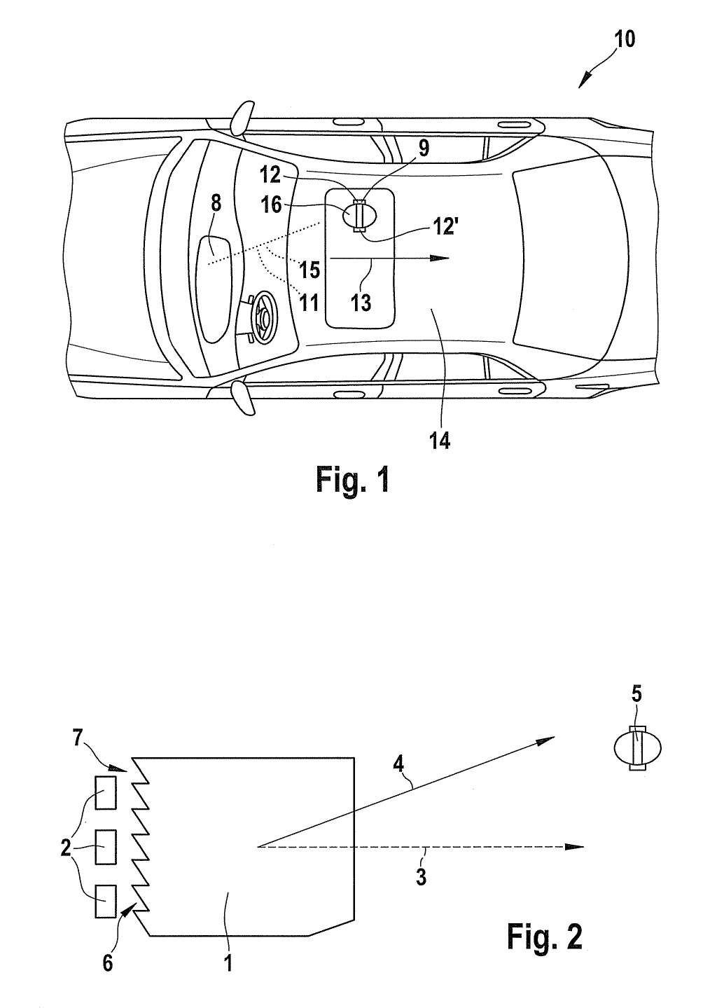

FIG. 1 illustrates a vehicle 10 in a schematic top view. An optical radiation source 2 which emits infrared signals 11, for example, is provided in front passenger compartment 14.

The preferred direction of infrared signals 11 is deflected as the result of a deflecting structure 1 (not illustrated in FIG. 1) situated in the beam path downstream from radiation source 2.

Deflected preferred direction 15, illustrated as a dotted line, transmits infrared signals 11 to the infrared receiver at position 9, which, for example, is integrated into headphones 12, 12′ of a passenger 16 sitting in vehicle 10.

Infrared signal 11 in deflected preferred direction 15 thus has a distinct divergence from axial longitudinal axis 13 of vehicle 10, infrared signals being oriented toward passenger 16 in a targeted manner.

FIG. 2 shows a schematic illustration of a deflecting structure 1; a radiation source 2 transmits infrared signals 11 in an original beam direction 3 to inclined surfaces 7 of a deflecting structure 1.

Inclined surfaces 7 are provided on a prism-shaped surface 6, for example, it also being possible for inclined surfaces 7 to be provided in an array.

Infrared signal 11 striking inclined surfaces 7 is deflected into a beam direction 4 due to the index of refraction of deflecting structure 1 (transition from a surrounding medium to a medium of higher optical density), resulting in a divergence from the original beam direction.

Infrared signals 11 exiting deflecting structure 1 are transmitted, with respect to deflected beam direction 4, to a position 9 of receivers 5 which, for example, are integrated into headphones 12, 12′ worn by a passenger 16 sitting in passenger compartment 14 of a vehicle 10 (also see FIG. 1).

To improve the reception quality, bundling of infrared signals 11 may likewise be carried out, using a bundling element (not illustrated), for example a Fresnel lens or a mirror, in the beam path of deflected beam direction 4.

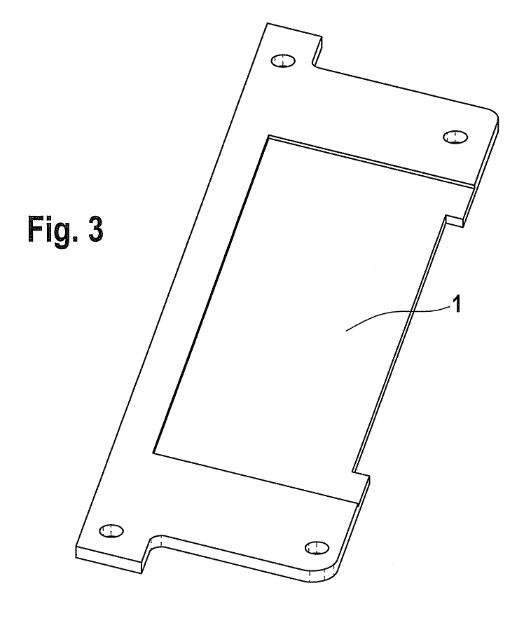

FIG. 3 shows a perspective illustration of a deflecting structure 1 having a relatively small thickness in relation to its planar extension. Deflecting structure 1 is therefore well suited for integrated installation in devices having a relatively low installation depth, for example in a central display of a vehicle 10.

It is further noted that prism-shaped surface 6 of deflecting structure 1 may be situated on the side associated with radiation source 2 to ensure that the surface facing a receiver 5 (not apparent from FIG. 3) is essentially smooth.

Corresponding to the previously described embodiment, prism-shaped surface 6 may be provided in an essentially planar surface structure, so that an increase in the thickness in relation to the planar extension of deflecting structure 1 may be avoided.

What is claimed is:

1. A device for vehicles for transmitting optical signals, comprising:
an optical radiation source having a specified beam characteristic including a preferred direction; and
a deflecting structure situated in a beam path downstream from the radiation source, by use of which the preferred direction of the beam characteristic may be deflected.

2. The device according to claim 1, where the optical signals are infrared signals.

3. The device according to claim 1, wherein the deflecting structure has an inclined surface relative to the beam direction of the radiation source.

4. The device according to claim 1, wherein the deflecting structure has a prism-shaped surface.

5. The device according to claim 1, wherein an optical unit bundles the optical signals.

6. The device according to claim 1, wherein the deflecting structure is transparent to infrared signals.

7. The device according to claim 1, wherein the deflecting structure is made of a black-colored material which is transparent to infrared radiation.

8. The device according to claim 1, wherein the radiation source includes an infrared LED.

9. The device according to claim 1, wherein the deflecting structure has a small thickness in relation to its planar extension.

10. The device according to claim 1, wherein the deflecting structure has an index of refraction which is different from an index of refraction of an adjacent medium at which an optical signal enters the deflecting structure.

11. The device according to claim 1, wherein the device is designed for irradiation by optical signals of a single position in a vehicle.

12. A method for transmitting optical signals, comprising:
transmitting optical signals originating from a radiation source having a specified beam characteristic in a preferred direction; and
using a deflecting structure situated in a beam path downstream from the radiation source to deflect the preferred direction of the beam characteristic.

13. The method according to claim 12, wherein the optical signals are infrared signals.
